(19) United States
(12) Patent Application Publication
(10) Pub. No.: US 2009/0316055 A1
(43) Pub. Date: Dec. 24, 2009

(54) REMOTE CONTROL

(75) Inventor: LUNG DAI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/485,934

(22) Filed: Jun. 17, 2009

(30) Foreign Application Priority Data
Jun. 19, 2008 (CN) 200810302208.3

(51) Int. Cl. H04N 5/44

(52) U.S. Cl. 348/734

(57) ABSTRACT

A remote control includes a display, a memory, a control unit, and an electronic dictionary stored in the memory. The electronic dictionary is configured for execution by the control unit to receive character information inputted in a first language, to translate the character information from the first language to a second language; and to display the character information in the second language by the display.

### BACKGROUND

1. Technical Field

The present disclosure relates to televisions (TVs), and more particularly to a remote control in association with a television.

2. Description of Related Art

Televisions are dumb terminals and reproduce video and audio information. Sometimes captions may be displayed simultaneously with the video and audio information. However, if the captions are in English and the viewer is a non-native English speaker, the viewer may have problems in comprehending some words of the caption in an English movie.

Therefore, it is desired to provide a remote control for overcoming the described shortcomings and deficiencies.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of a television in association with a remote control in accordance with an exemplary embodiment.

FIG. 2 is a top view of the remote control of FIG. 1 in accordance with an exemplary embodiment.

FIG. 3 is a block diagram of the remote control of FIG. 2 in accordance with an exemplary embodiment.

### DETAILED DESCRIPTION

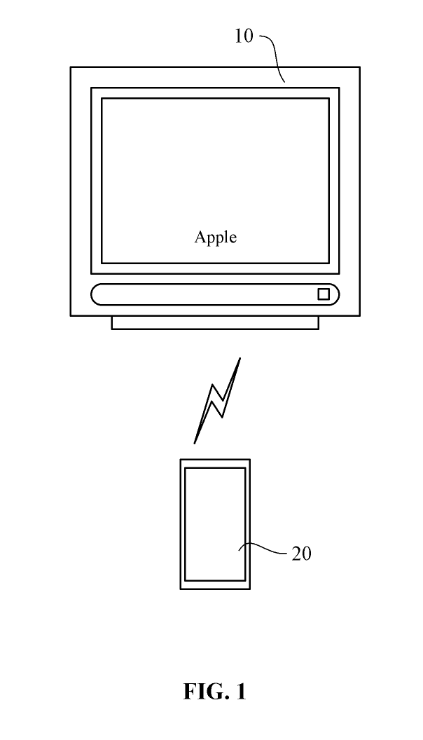

Referring to FIG. 1, a schematic diagram of a television 10 in association with a remote control 20 in accordance with an exemplary embodiment is illustrated. In normal mode, the television 10 is controlled by the remote control 20 to adjust various settings, such as television channel and/or volume. The remote control 20 may be configured in a dictionary mode. In the dictionary mode, the remote control 20 may be operated to translate information such as a subtitle or a TV menu, to better understand the information.

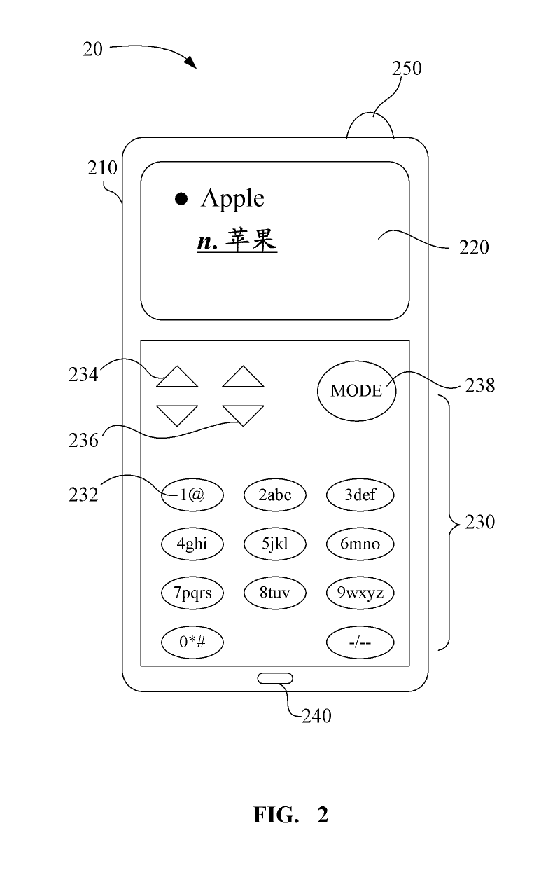

Referring to FIG. 2, a top view of the remote control 20 of FIG. 1 is illustrated. The remote control 20 may include a housing 210, a display 220, a keypad 230, a speaker 240, and a transmitter 250.

The housing 210 may include a structure to contain components of the remote control 20. For example, the housing 210 may be formed from plastic or metal and may support the display 220, the keypad 230, the speaker 240, and the transmitter 250.

The display 220 may include any component capable of providing visual information. For example, in one implementation, the display 220 may be a liquid crystal display (LCD). In another implementation, the display 220 may be a light emitting diode (LED) display.

The keypad 230 may include any component capable of providing inputs to the remote control 20. The keypad 230 may include a plurality of input keys 232. The plurality of input keys 232 are appropriately arranged like a typical telephone keypad. Each of the plurality of keys 232 is associated with a number and multiple characters/letters. The keypad 230 may also include channel keys 234 and volume keys 236. The channel keys 234 are configured for selecting channels of the television 10. It should be noted that the channels can also be selected by the plurality of keys 232. The volume keys 236 are configured for adjusting the volume of the television 10. The keypad 230 may further include a mode selection key 238. The mode selection key 238 changes the mode of the remote control 20 between a normal mode and a dictionary mode. When the mode selection key 238 is actuated to change the remote control 20 to the normal mode, the plurality of keys 232 may be operated to input a channel number of the television 10. When the mode selection key 238 is actuated to switch the remote control 20 to the dictionary mode, the plurality of keys 232 may be operated to enter a word entry. In one implementation, each key of the keypad 230 may be, for example, a pushbutton, an area on a touch-sensitive screen, etc.

The speaker 240 may include any component capable of converting an electrical signal to a corresponding sound wave.

The transmitter 250 may include any component capable of issuing a command for transmitting operation to the television 10. In one implementation, the command is transmitted to the television via infrared.

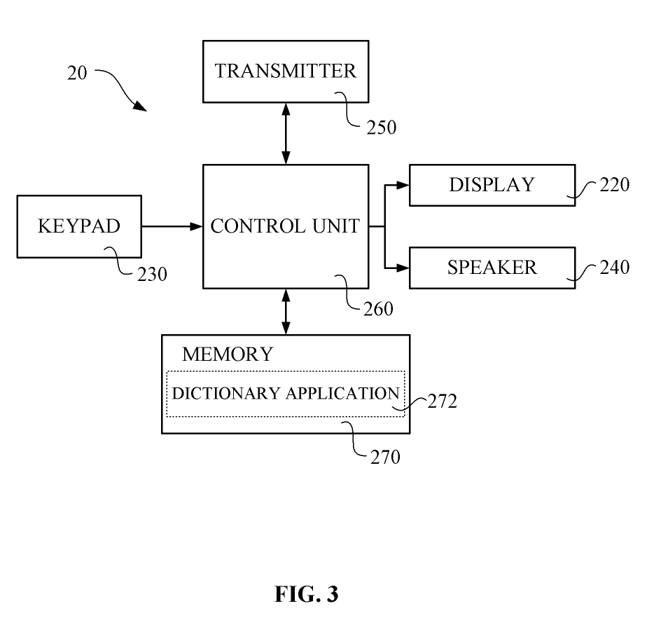

Referring to FIG. 3, a block diagram of the remote control 20 of FIG. 2 is illustrated. As illustrated, the remote control 20 may include a display 220, a keypad 230, a speaker 240, a transmitter 250, a control unit 260, and a memory 270. The display 220, keypad 230, speaker 240, and transmitter 250 may include the features and/or capabilities described above in connection with FIG. 2.

The control unit 260 may include any logic that access instructions from the memory 260, and interprets and executes instructions to control the overall operation of the remote control 20. As used herein, the term “logic” may include hardware, software, and/or a combination of hardware and software. The control unit 260 may include, for example, a general-purpose processor, a microprocessor, a data processor, a co-processor, a network processor, an application specific integrated circuit (ASIC), a controller, a programmable logic device, a chipset, a field programmable gate array (FPGA), etc.

The memory 270 may include any type of storage component that stores data and instructions related to the operation and use of the remote control 20. For example, the memory 270 may include a memory component, such as a random access memory (RAM), a dynamic random access memory (DRAM), a static random access memory (SRAM), a synchronous dynamic random access memory (SRAM), a ferroelectric random access memory (FRAM), a read only memory (ROM), a programmable read only memory (PROM), an erasable programmable read only memory (EPROM), an electrically erasable programmable read only memory (EEPROM), and/or a flash memory.

The memory 270 further stores an electronic dictionary 272. The electronic dictionary contains software instructions. The software instructions may be read out of the memory 270 and may be interpreted and executed by the control unit 260 to perform processes of translating character information.

Although FIG. 2 illustrates exemplary components, in other implementations, fewer, additional, and/or different internal components than the internal components depicted in FIG. 2 may be employed. For example, the remote control 20 may not include the speaker 220.

In operation, the remote control 20 may be operated to actuate the mode selection key 238, so as to change the remote control 20 to the dictionary mode. In the dictionary mode, the electronic dictionary 272 stored in the memory 270 may be invoked by the control unit 260 to perform at least following actions:

First, a word entry inputted by the plurality of keys 232 is received. The character information may be inputted in a first language.

Second, the word entry is translated from the first language to a second language. In one implementation, the character information may be translated from English to Chinese.

Third, the translated character information is outputted.

For example, a user may watch an English movie, and the user may not understand the meaning of the English word “Apple”. Then, the English word “Apple” is inputted to the remote control 20 via the plurality of keys 232 and the English word “Apple” is translated to the equivalent Chinese characters for “Apple” and these Chinese characters are displayed in the display 220 or may be output as audible sounds via the speaker 240.

In addition, in the dictionary mode, the transmitter 250 may be disabled. As such, the remote control is restricted from issuing commands to the television 10 in the dictionary mode. Moreover, in the normal mode, the dictionary function is restricted.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A remote control for remotely controlling a television, the remote control comprising:
an input unit arranged with a mode selection key, the mode selection key capable of being actuated to change the remote control between a normal mode for adjusting various settings of the television and a dictionary mode for translating character information displayed by the television;
a memory;
a control unit; and
an electronic dictionary stored in the memory and configured for execution by the control unit;
wherein the electronic dictionary is capable of being invoked by actuating the mode selection key of the input unit, whereby the remote control is changed to the dictionary mode, the electronic dictionary comprises instructions to:
receive character information inputted from the input unit in a first language;
translate the character information from the first language to a second language; and
output the character information in the second language.

2. The remote control according to claim 1, further comprising: a transmitter, wherein when the remote control is changed to the normal mode by actuating the mode selection key of the input unit, the transmitter is enabled to issue commands to the television, and when the remote control is changed to the dictionary mode by actuating the mode selection key of the input unit, the transmitter is disabled to issue commands to the television.

3. The remote control according to claim 1, wherein the input unit comprises a plurality of keys, when the remote control is changed to the normal mode, each of the plurality of keys is associated with a numeric number for entering a channel number; when the remote control is changed to the dictionary mode by actuating the mode selection key of the input unit, each of the plurality of keys is associated with multiple characters for entering the character information.

4. The remote control according to claim 1, further comprising a display, the character information in the second language is displayed in the display.

5. The remote control according to claim 4, wherein the display comprises a liquid crystal display.

6. The remote control according to claim 1, further comprising a speaker, the character information in the second language are outputted as audible sounds via the speaker.

7. The remote control according to claim 1, wherein the first language is English, the second language is Chinese.

8. A remote control for facilitating a user to recognize character information displayed by a television, the remote control comprising:
a memory;
a control unit; and
an electronic dictionary stored in the memory and configured for execution by the control unit, the electronic dictionary comprises instructions to:
receive character information inputted in a first language;
translate the character information from the first language to a second language; and
output the character information in the second language.

9. The remote control according to claim 8, further comprising: a transmitter, wherein when electronic dictionary is executed by the control unit, the transmitter is disabled to issue commands to the television.

10. The remote control according to claim 8, further comprising: an input unit arranged with a mode selection key, the mode selection key capable of being actuated to change the remote control between a normal mode for adjusting various settings of the television and a dictionary mode for translating character information displayed by the television.

11. The remote control according to claim 8, wherein the input unit comprises a plurality of keys, when the remote control is changed to the normal mode, each of the plurality of keys is associated with a numeric number for entering a channel number; when the remote control is changed to the dictionary mode by actuating the mode selection key of the input unit, each of the plurality of keys is associated with multiple characters for entering the character information.

12. The remote control according to claim 8, further comprising a display, the character information in the second language is displayed in the display.

13. The remote control according to claim 12, wherein the display comprises a liquid crystal display.

14. The remote control according to claim 8, further comprising a speaker, the character information in the second language are outputted as audible sounds via the speaker.

15. The remote control according to claim 8, wherein the first language is English, the second language is Chinese.
